(19) United States
(12) Patent Application Publication
(10) Pub. No.: US 2026/0175774 A1
(43) Pub. Date: Jun. 25, 2026

(54) Vehicle U-Turn Indication System Utilizing Existing Turn Signal Infrastructure

(71) Applicant: Wen Xin Na, Marriottsville, MD (US)

(72) Inventor: Wen Xin Na, Marriottsville, MD (US)

(21) Appl. No.: 19/171,222

(22) Filed: Apr. 5, 2025

Related U.S. Application Data
(60) Provisional application No. 63/737,863, filed on Dec. 23, 2024.

(51) Int. Cl. B60Q 1/38; B60K 35/10; B60K 35/22; B60Q 1/26; B60Q 1/34; B60R 1/22; B60W 50/14; G06F 8/65; G06F 9/451

(52) U.S. Cl. CPC B60Q 1/381; B60K 35/10; B60K 35/22; B60Q 1/2696; B60Q 1/343; B60R 1/22; B60W 50/14; G06F 8/65; G06F 9/454

(57) ABSTRACT

The present invention provides a vehicle U-turn signaling system designed to enhance road safety by clearly communicating a driver's intent to perform a U-turn. Leveraging existing vehicle turn signal infrastructure, the system generates a distinctive blinking pattern visually and temporally different from standard turn signals, ensuring immediate recognition by nearby drivers, pedestrians, or traffic personnel. Implementation methods include updating the vehicle's electronic software or integrating a dual-pattern flasher module, requiring minimal hardware modifications. Activation methods encompass double-clicking the existing turn signal lever, using a dedicated button, a virtual interface, or voice command via the vehicle's voice-assistant system. Dashboard indicators replicate the U-turn signal's unique pattern, featuring optional symbolic or language-specific cues for global use. Additional features include synchronized auditory feedback and optional integration with cameras and proximity sensors for obstacle detection. The system provides a cost-effective and adaptable solution for improved vehicle signaling during complex turning maneuvers.

### CROSS REFERENCE TO RELATED APPLICATIONS

This application claims the benefit of U.S. Provisional Application No. 63/737,863 filed on Dec. 23, 2024. The entire contents of the above-identified applications are hereby fully incorporated herein by reference.

### TECHNICAL FIELD

The subject matter disclosed herein is generally directed to vehicle signaling systems designed to improve safety during U-turn maneuvers. More specifically, the invention relates to a signaling system that utilizes existing vehicle lighting and control infrastructure to generate distinct U-turn blinking patterns, ensuring clear communication of a vehicle's intent and adaptability for various vehicle types and driving conditions.

### BACKGROUND

Motor vehicles are equipped with turn signal indicators to alert other drivers and pedestrians when a vehicle intends to turn, as well as the direction of the intended turn. These signals, involving flashing lights at the front, rear, and sometimes the sides of the vehicle, provide advance notice to surrounding road users, allowing them to anticipate a possible reduction in speed as the vehicle prepares to turn. While these indicators effectively communicate left and right turn intentions, including merge lane interactions, they do not accommodate situations where a vehicle intends to perform a U-turn, which may involve a more significant reduction in speed and a larger turning radius.

The process of making a U-turn, which involves a near 180-degree change in direction, often requires a vehicle to decelerate more than it would for a standard turn. This can lead to dangerous misunderstandings with other road users. Drivers following behind may misinterpret a left or right turn signal, assuming the vehicle will make a normal turn rather than a U-turn, potentially causing a rear-end collision due to the unexpected slow-down. Similarly, oncoming drivers may anticipate a typical turn and fail to reduce their speed sufficiently to accommodate the vehicle completing the U-turn. Additionally, pedestrians might misjudge the vehicle's intended path, increasing the risk of stepping into its path during the maneuver. Thus, a U-turn is a complex and potentially hazardous maneuver that could benefit significantly from a dedicated signaling system.

Current vehicle signaling systems, designed by original equipment manufacturers (OEMs), typically include turn indicators activated by a lever arm near the steering wheel. These signals utilize factory-installed lighting assemblies, such as turn signals or hazard lights, that alert others to the vehicle's movements. However, there is no specialized signal for U-turns, and drivers often rely on the existing turn signals to indicate their intentions. This ambiguity in communication can lead to accidents, as nearby drivers and pedestrians may not accurately interpret the vehicle's movements when a U-turn is intended.

There has been a persistent demand for a dedicated U-turn signal system that is simple to operate, effectively communicates the driver's intent to perform a U-turn, and can be incorporated as either an aftermarket addition or an OEM feature. Unlike regular turn signals, the U-turn signal employs a distinct and eye-catching blinking pattern that is specifically designed to be easily recognizable by both drivers and pedestrians. This differentiation ensures that the intention to execute a U-turn is unmistakable, thereby reducing the risk of misinterpretation, collisions, and pedestrian injuries. Additionally, a convenient and easily retrofitted U-turn indicator provides a valuable solution, enhancing road safety by clearly conveying the unique nature of a U-turn maneuver to all road users.

### SUMMARY

The present invention provides a U-turn signaling system for vehicles, designed to improve road safety by effectively communicating a driver's intent to perform a U-turn. By utilizing the vehicle's existing turn signal infrastructure, this system allows for a distinct U-turn indication pattern that can be easily integrated into current vehicle designs or retrofitted as an aftermarket feature. The U-turn signal system employs a unique flashing pattern that visually and temporally differentiates it from regular left or right turn signals, thereby indicating the vehicle's intention to make a 180-degree directional change. Notably, the system requires no exterior changes to the vehicle, ensuring that adding the U-turn signal is simple and cost-effective. By making use of the existing lighting and electrical systems, the design is easy to implement and seamlessly integrates with the vehicle's current setup.

In one embodiment, the system includes a specialized dual-pattern flasher module or an updated electronic control system that enables two distinct flashing patterns-one for regular turns and one specifically for U-turns. The U-turn pattern, characterized by a series of consecutive illuminated pulses followed by off intervals, is designed to capture the attention of nearby drivers and pedestrians, thereby reducing the risk of misinterpretation. This distinctive signaling method helps prevent rear-end collisions, misjudgments by oncoming vehicles, and potential hazards to pedestrians who may otherwise mistake a U-turn for a standard left or right turn. The U-turn signal is designed to be easily distinguishable from regular turn signals while complying with federal regulations like FMVSS No. 108, which standardizes vehicle signaling systems across all states in the United States. Its adaptable design allows seamless and safe integration into various traffic systems.

In another embodiment, the U-turn signaling system incorporates a chaser-style lighting system characterized by sequential illumination patterns, providing an enhanced visual distinction from standard turn signals. The chaser-style lighting pattern comprises multiple illumination sequences with distinctly different durations grouped to attract attention and effectively indicate the intention to perform a U-turn. Examples include flashing two rapid illumination sequences followed by one slower illumination sequence. The pattern can be further customized, such as lights illuminating inward from sides to the center, outward from the center to sides, or sequentially from left to right and then back from right to left (e.g., 1-2-3-4-5-4-3-2-1), ensuring clear differentiation from standard signals and improving recognition by nearby road users. This customizable configuration enhances driver intent communication and overall road safety.

In one embodiment, the system includes multiple user-friendly activation options to accommodate various vehicle types and driver preferences. For conventional vehicles, the U-turn signal can be activated by double-clicking the existing turn signal lever. An additional double-click feature may be incorporated into the existing turn signal switch specifically for initiating the U-turn signal, allowing drivers to activate the U-turn signal without requiring any new components. Alternatively, a dedicated switch button can be added to the end of the turn signal lever, similar to the rear window wiper switch setup in some vehicles, providing another intuitive activation option. In electric vehicles, where software modifications are more accessible, an additional U-turn button can be programmed into the control interface. In another embodiment, the U-turn signaling system supports voice activation via the vehicle's integrated voice assistant. This flexibility in activation methods ensures ease of use and minimizes the impact on existing driving habits.

In one embodiment, the system is designed to adapt to both left-hand and right-hand drive configurations, ensuring global usability. The placement of activation mechanisms and the timing of blinking patterns are configured ergonomically to accommodate the driver's seating location in both driving configurations. Additionally, the system's control module is preprogrammed with region-specific traffic signaling standards, enabling compliance with local laws.

In one embodiment, the U-turn signal is combined with the existing turn indicator light on the vehicle's dashboard. The dashboard indicator light mirrors the U-turn signal's unique blinking pattern, while an additional “U” symbol or the global standard ‘U-Turn’ symbol (FIG. 4) appears on the dashboard when the U-turn signal is activated. This provides a clear visual cue to the driver, enabling them to easily verify the status of the U-turn signal and distinguish it from a standard turn signal. To further enhance global applicability, the dashboard indicator integrates a language-specific cue or universally recognizable symbol, ensuring comprehensibility across different regions and accommodating diverse language preferences. This alignment promotes driver awareness, supporting safe and intentional maneuvering while enhancing usability in international contexts.

In one embodiment, the U-turn signal system integrates with vehicle cameras and proximity sensors. Activating the U-turn signal triggers a rear or side-view camera, providing real-time visuals on the vehicle's infotainment screen to assist the driver in monitoring their surroundings. Additionally, proximity sensors linked to the system can emit an alert if obstacles or pedestrians are detected in the vehicle's turning path, thereby minimizing collision risks.

In one embodiment, the system includes an automatic adjustment feature for the flashing intensity based on ambient light conditions. Integrated light sensors detect surrounding light levels and adjust the brightness and flashing rate of the U-turn signal, ensuring optimal visibility during both daytime and nighttime driving conditions.

In one embodiment, the system allows customizable flashing patterns for different types of turns, such as U-turns and K-turns. Each maneuver can be associated with a specific flashing pattern or rate, providing a clear and differentiated signal to other drivers and pedestrians about the nature of the intended turn.

In one embodiment, the U-turn signaling system matches the click sound pattern inside the vehicle to the U-turn signal's unique flashing pattern. This synchronization of the click sounds with the U-turn blinking sequence provides an intuitive auditory cue that complements the visual indicator, enhancing driver awareness and reinforcing the activation of the U-turn signal. By aligning the sound with the specific U-turn flash pattern, this feature supports clear and consistent feedback for the driver during the maneuver.

This U-turn signaling system not only provides a clear and recognizable indication of the driver's intent to perform a U-turn but also offers a cost-effective solution by leveraging the existing vehicle lighting and control systems. The invention may be implemented through minimal hardware modifications, such as replacing or reprogramming the turn signal flasher, or through software updates in vehicles with electronic controls. The invention thus represents an efficient and scalable approach to addressing safety concerns associated with U-turns, meeting a longstanding need for improved vehicular communication in complex driving scenarios.

### BRIEF DESCRIPTION OF THE DRAWINGS

FIG. 1: Comparison of Standard Turn Signal Pattern and Unique U-Turn Flashing Patterns with Defined Timing. FIG. 1 illustrates the comparison between the normal turn signal flash pattern and the unique U-turn signal patterns, highlighting their distinct visual and temporal characteristics. Normal turn signals operate with a steady interval flash pattern, cycling 60 to 120 times per minute or following a single-duration flash sequence. In contrast, the U-turn signal employs a unique flash pattern designed to include two or more visually and temporally differentiated duration groups, ensuring clear distinction from standard turn signals. This unique pattern enhances the visibility of U-turning vehicles, particularly when waiting in a left-turn lane at traffic lights, allowing them to be easily recognized by other road users.

FIG. 2: Illustration of Chaser-Style Sequential Flashing Patterns for Regular Turn and U-Turn Signals. The upper sequence demonstrates a standard chaser-style turn signal with uniformly spaced intervals. The lower sequence illustrates the unique U-turn chaser pattern, characterized by two rapid sequential flashes followed by one slower sequential flash, repeated cyclically until the signal is switched off.

FIG. 3: Illustration of Existing Vehicle Turn Signal Integration for U-Turn Functionality. FIG. 3 illustrates the integration of the U-turn signaling system with all existing vehicle turn signal lighting infrastructure, for example, the front, mirror-mounted, and rear turn signals. This integration leverages pre-installed hardware, reducing installation costs and simplifying retrofitting. The control module activates the U-turn signal across all visible lighting points to ensure comprehensive visibility to surrounding drivers and pedestrians. No additional external lighting hardware is required.

FIG. 4: Dashboard and Control Lever Integration for U-Turn Signal Activation and Feedback. FIG. 4 shows the integration of the U-turn signaling system with the vehicle's dashboard indicator and turn signal lever. The diagram highlights the following features: U-Turn Indicator on Dashboard: A green U-turn indicator is added to the dashboard, blinking in synchronization with the external U-turn signals. This provides the driver with a clear visual confirmation of the U-turn signal activation. Auditory Feedback: The U-turn click sound is synchronized with the U-turn indicator blink pattern, offering auditory feedback that aligns with the visual signal for enhanced driver awareness. Turn Signal Lever Functionality: The turn signal lever is shown with a U-turn activation mechanism, where the lever can be pushed past the “Left Turn” position to a designated “U-Turn” position. This intuitive control triggers the unique U-turn signal pattern without requiring additional Steering Column control components.

FIG. 5: U-Turn and Turn Signal System Wiring Diagram. FIG. 5 provides a schematic representation of the wiring diagram for the U-turn signaling system, showing its integration with the vehicle's existing turn signal and electrical components. Key elements include: 4-Way Turn Signal Switch: The diagram depicts the multi-position turn signal switch, allowing the selection of Right, Off, Left, or U-Turn positions. The pivot point connects these positions to the respective relays. Turn Signal Blinker Relay: This component generates the standard turn signal blinking pattern for Left and Right turns. U-Turn Signal Blinker Relay: Dedicated for creating the distinct U-turn blinking pattern, the relay ensures the unique flashing sequence is activated upon selecting the U-Turn position. Indicator Integration: Both Left and Right Turn Indicators, along with the U-Turn Indicator on the dashboard, are connected to their respective relays, providing synchronized visual feedback. Lighting System: The wiring extends to the Left and Right lamps of the vehicle, coordinating their operation with the corresponding turn signal or U-turn blinking pattern. This diagram illustrates how the U-turn signaling system seamlessly integrates into the vehicle's electrical infrastructure, utilizing existing components while adding new functionality for U-turn signaling.

### DETAILED DESCRIPTION OF THE EXAMPLE EMBODIMENTS

The embodiments described herein are provided as examples to illustrate the principles of the invention and are not intended to limit its scope. The systems, methods, and apparatuses discussed may take on numerous other configurations and implementations. Variations, modifications, and substitutions of the described features may be made without departing from the overall scope and intent of the invention.

### I. Distinct Blinking Pattern for U-Turn Signals

In one embodiment, the U-turn signaling system employs a distinct blinking pattern characterized by sequences of illuminated (“ON”) and off (“OFF”) states. Each “ON” state represents the light being illuminated for a defined duration, for example, 0.4 seconds, and each “OFF” state represents the light being off for a defined duration, for example, 0.2 seconds. For U-turn patterns, grouped illuminations such as “ON-ON” or combinations of short and long durations provide a unique signal easily distinguishable from standard turn signals. This distinct pattern clearly communicates the vehicle's intent to perform a 180-degree turn, ensuring safe and effective road communication.

Unlike normal turn signals, which flash in a steady interval pattern at 60-120 times per minute or feature single-duration flash patterns, the U-turn signal employs a unique flashing pattern consisting of two or more visually and temporally different duration groups. This ensures that vehicles waiting in left-turn lanes at traffic lights can distinctly identify U-turn vehicles based on their specific signal patterns. The U-turn signal's unique rhythm helps differentiate it from standard turn signals, improving clarity for both drivers and pedestrians.

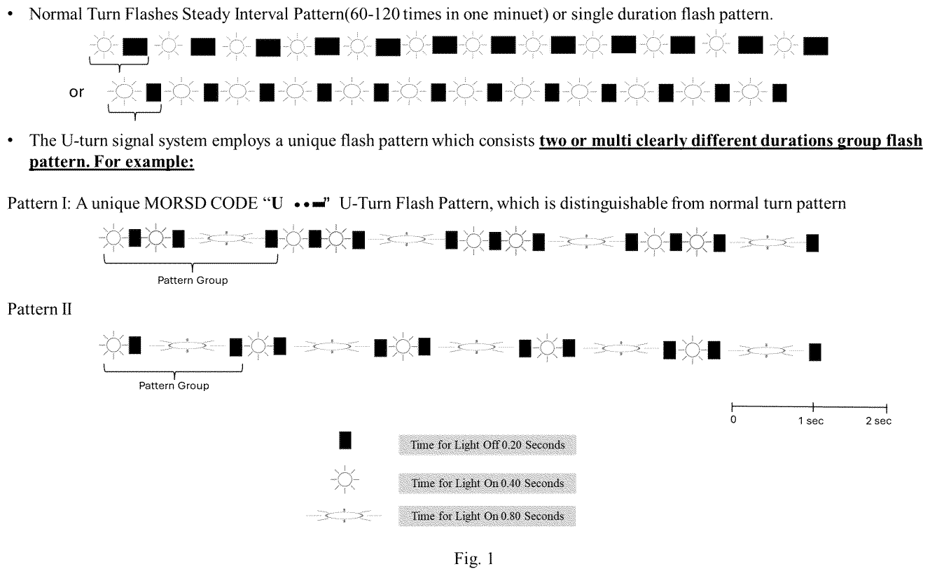

For instance, a typical turn signal pattern alternates between illuminated and off states in a steady rhythm, such as “ON-OFF-ON-OFF,” where each “ON” lasts 0.4 seconds and each “OFF” lasts 0.2 seconds. In contrast, U-turn patterns introduce sequences with varying durations, ensuring distinctiveness and avoiding confusion with standard turn signals. The specific patterns in FIG. 1 are as follows:

Normal Turn Signal Pattern: Alternates as “ON-OFF-ON-OFF-ON-OFF,” where each “ON” lasts 0.4 seconds, and each “OFF” lasts 0.2 seconds.

U-Turn Pattern I: Alternates as “ON-OFF-ON-OFF-ON-ON-OFF,” repeated cyclically. Each “ON” lasts 0.4 seconds, “ON-ON” represents 0.8 seconds of continuous illumination, and each “OFF” lasts 0.2 seconds. This pattern is designed to mimic the Morse code letter “U” (“ . . . ”), representing two short illuminations followed by one long illumination. This intuitive and symbolic approach not only provides a clear visual distinction but also adds an identifiable and memorable signal for surrounding road users.

U-Turn Pattern II: Alternates as “ON-ON-ON-OFF-ON-ON-OFF-ON-OFF,” where “ON-ON-ON” represents 1.2 seconds of continuous illumination, followed by a 0.2-second off interval. This extended pattern ensures visibility in scenarios like high-speed roadways.

U-Turn Pattern III: Combines short and long pulses, alternating as “ON-ON-OFF-ON-OFF-OFF-ON-ON-OFF,” where each “ON” lasts 0.4 seconds, “ON-ON” represents 0.8 seconds, and “OFF” lasts 0.2 seconds. This distinct grouping improves safety in high-density traffic environments.

U-Turn Pattern IV: Alternates as “on-off-on-off-on-off-on-on-off,” where each “on” represents 0.1 seconds, and each “off” represents 0.1 seconds. The final “on-on” represents 0.2 seconds of continuous illumination. This high-frequency blinking pattern captures immediate attention in high-risk environments such as busy intersections or low-visibility conditions. The rapid alternation ensures the U-turn signal is unmistakably distinct from regular turn signals, while adhering to visibility and recognition standards.

These patterns ensure that the U-turn signal can visually and temporally differentiate itself from normal turn signals while complying with local traffic regulations. By utilizing the vehicle's existing turn signal lamps and integrating unique flashing configurations, the system minimizes the need for additional hardware and keeps installation costs low. The integration is seamless, ensuring compatibility with existing vehicle systems and enhancing user convenience.

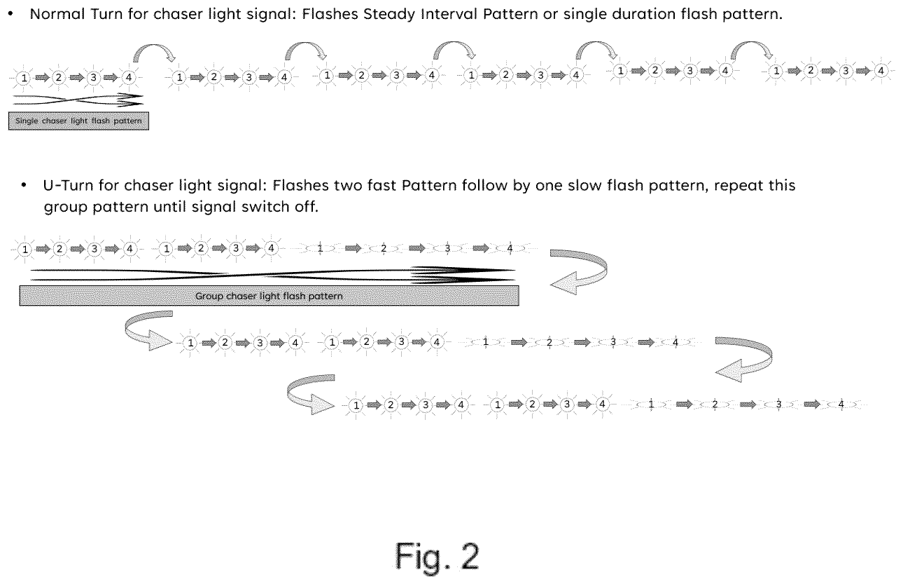

In another embodiment, illustrated in FIG. 2, the U-turn signaling system employs a distinct chaser-style blinking pattern characterized by sequential activation of individual turn signal lights, creating a dynamic and directional visual effect that is clearly distinguishable from standard sequential turn signals. The chaser-style pattern activates individual turn signal lights in rapid succession, generating an intuitive visual indication of the driver's intent to execute a U-turn.

A conventional chaser-style turn signal typically involves sequential illumination of lights at consistent intervals, resulting in a uniform visual rhythm. In contrast, the U-turn chaser pattern employs grouped illuminations with varied durations, enhancing the visual distinctiveness. For example, the lights may flash rapidly from the vehicle sides toward the middle, followed by a slower illumination moving from the middle back to the sides, clearly differentiating it from regular sequential signals. Alternative group patterns include lights moving from the middle outward, or alternations between rapid outward and inward illumination sequences. These configurations provide flexibility in creating visually distinctive patterns adaptable to diverse road and traffic conditions.

This grouped chaser flashing pattern leverages existing sequential or segmented turn signal lights, requiring minimal modification to existing vehicle hardware. Implementation can typically be achieved via software updates to the vehicle's electronic control module or by incorporating a dual-pattern flasher module, thus maintaining ease of integration and cost efficiency. Consequently, vehicles waiting in left-turn lanes at intersections can be readily identified by other drivers as intending to make U-turns, reducing confusion and improving safety.

By employing sequences with two or more clearly distinct durations, the U-turn signaling system enhances versatility while maintaining clear communication. This allows it to accommodate varying traffic environments, improve road safety, and clearly signal U-turn intentions, even in regions with specific traffic regulations or lighting conditions.

The U-turn flashing pattern can be implemented through different approaches:
a. Modifications to the turn signal flasher: The existing flasher module can be replaced with a specialized dual-pattern flasher designed to generate the U-turn pattern in addition to standard turn signal patterns.
b. Updates to the vehicle's electronic control system: For vehicles with advanced electronic systems, software updates can introduce the U-turn signal functionality without requiring additional hardware.
c. Ergonomic placement of activation mechanisms based on vehicle configurations, accommodating both left-hand and right-hand drive vehicles, ensuring the system's usability in diverse regions.

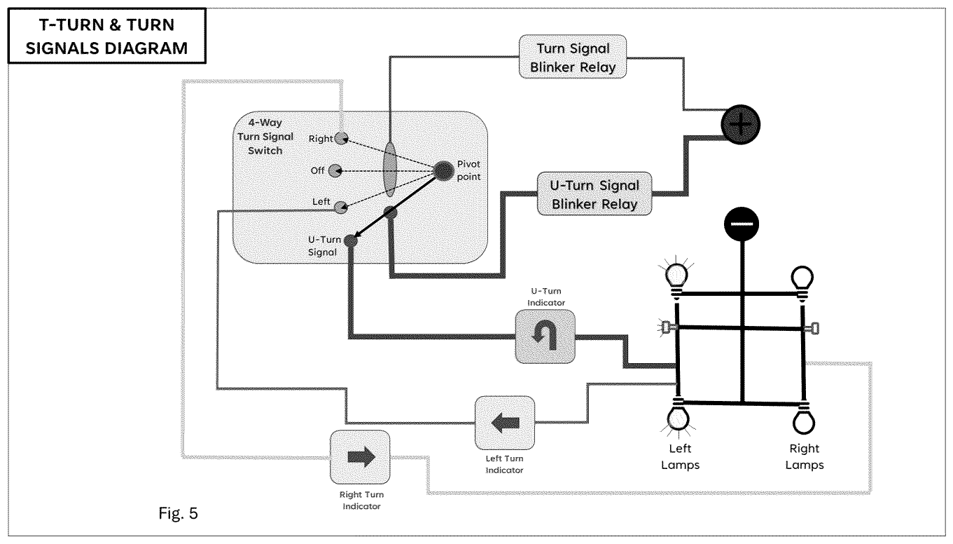

With minimum adjustment, the vehicle scheme is integrated into the existing wiring whilst implementing the U-turn signaling system (FIG. 5). The construction uses a 4-way turn signal switch that can be set to Right, Off, Left, or U-Turn modes and rotates about a center pivot that routes to the appropriate relay. A dedicated turn blinker relay controls the distinctive flashing sequence needed for U-turns, while the conventional blinker relay controls the Left and Right turn signals. The wire also connects the car's external lamps and dashboard indicators, allowing for seamless synchronization between signals and feedback. Such integration allows its implantation in the car at low cost and without requiring significant modifications to the existing electrical system of the vehicle. Additionally, accommodating left-hand and right-hand drive vehicles enables international application, allowing vehicles to be designed for various regions where different traffic regulations apply.

The distinct U-turn flashing pattern enhances the safety of the maneuver by reducing the risk of misinterpretation. For instance, other drivers may misjudge a U-turn as a standard left or right turn when only a typical signal is used. The rhythmic and distinctive flashing pattern ensures that surrounding drivers and pedestrians can easily recognize the vehicle's intention, thereby preventing potential accidents such as rear-end collisions or pedestrian crossings into the turning path.

By providing a broad scope for blinking patterns and timing configurations, the U-turn signaling system is highly adaptable across various vehicle types and driving conditions. This embodiment ensures that the vehicle's intentions are clearly communicated, contributing to safer driving environments and better road communication.

### II. User-Friendly Activation Options for U-Turn Signals

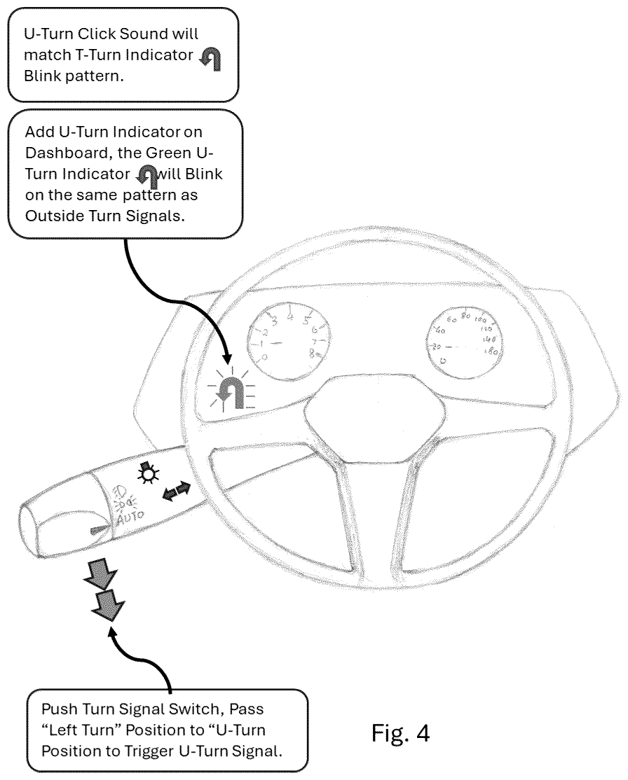

In one embodiment, the U-turn signaling system offers multiple user-friendly activation options designed to cater to various vehicle types and driver preferences. For conventional vehicles, the system allows the U-turn signal to be activated by double-clicking the existing turn signal lever as shown in FIG. 4. This double-click functionality is incorporated into the current turn signal switch, enabling the driver to initiate the U-turn signal using familiar controls without the need for additional hardware. This intuitive activation method reduces the learning curve for drivers while ensuring seamless integration into their driving habits.

In another configuration, the system may include a dedicated switch button placed at the end of the turn signal lever. This design is similar to the configuration often used for rear window wiper controls, providing an ergonomic and easily accessible option for activating the U-turn signal. The dedicated button offers a clear and distinct mechanism for initiating the U-turn signal, further enhancing usability and reducing the likelihood of accidental activation.

For electric vehicles, where advanced software-based features are more easily implemented, an additional U-turn button can be programmed into the vehicle's control interface. For example, a touch-sensitive display or dashboard control panel may include a virtual button labeled “U-Turn.” Upon activation, the U-turn signal triggers the designated blinking pattern. This software-based approach not only simplifies implementation but also offers flexibility for future updates or feature enhancements.

In one embodiment, the U-turn signaling system supports voice activation via the vehicle's integrated voice assistant. A predefined command, such as “Activate U-Turn Signal,” allows drivers to initiate the U-turn pattern hands-free, enhancing convenience and safety. This feature is particularly useful in situations where manual activation is impractical, ensuring seamless operation while leveraging existing voice recognition capabilities.

The system's versatility extends to accommodating specific driver preferences and vehicle designs. For instance, a driver may choose between the double-click functionality or the dedicated button based on their comfort and driving style. Similarly, vehicle manufacturers can tailor the activation method to align with the design philosophy of their models, ensuring a seamless user experience. The system is further configured to adapt activation methods ergonomically for left-hand and right-hand drive configurations, ensuring usability across diverse vehicle designs and driving practices. Preprogrammed regional traffic signaling standards can also be integrated into the control module to ensure compliance with local laws.

For example: a driver in a conventional sedan initiates the U-turn signal by double-clicking the turn signal lever, which then activates the unique blinking pattern for U-turns. In contrast, a driver in an electric vehicle simply presses the “U-Turn” button on the infotainment system, achieving the same result through a software-driven interface. Both approaches provide consistent functionality while addressing the specific needs of different vehicle types.

### III. Dashboard Integration with U-Turn Indicator and “U” Symbol

In one embodiment, the U-turn signaling system integrates with the vehicle's dashboard turn indicator light to provide an enhanced visual cue for the driver. When the U-turn signal is activated, the dashboard indicator light mirrors the unique blinking pattern of the external U-turn signal, ensuring consistency between the interior and exterior signaling, as shown in FIG. 4. This alignment provides consistent visual feedback to the driver, enabling them to confirm activation at a glance. The auditory click sound is also synchronized with the blinking pattern, reinforcing driver awareness through tactile and auditory feedback. For example, each illuminated pulse (‘1’) corresponds to a click sound, and each off state (‘0’) remains silent.

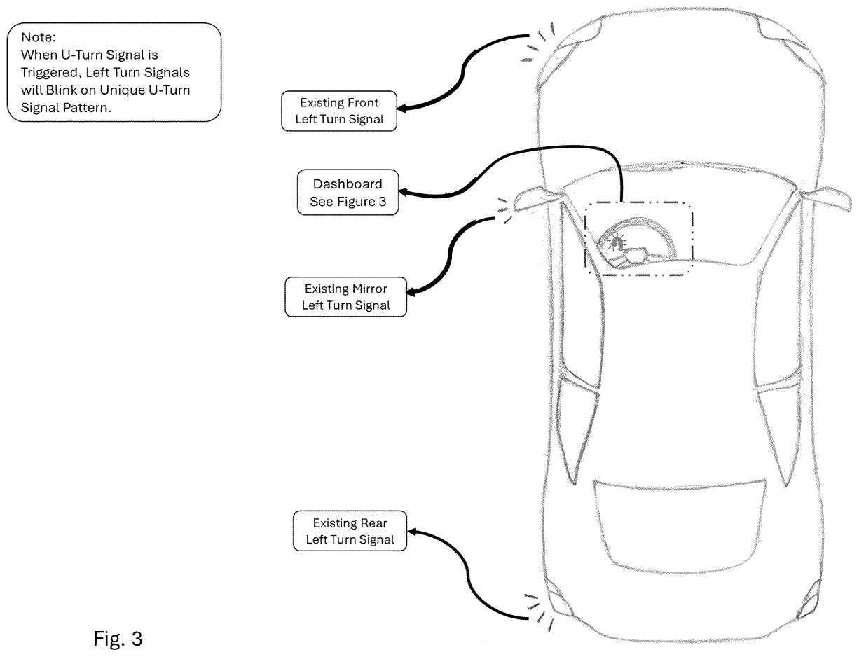

To further differentiate the U-turn signal from standard turn signals, a standard U-turn symbol appears within the turn signal indicator on the dashboard whenever the U-turn signal is engaged as shown in FIG. 3. This symbol provides a clear and unambiguous visual cue, enabling drivers to quickly confirm that the correct signal has been activated. For instance, during a nighttime U-turn, the presence of the U-turn symbol eliminates any uncertainty about whether the signal is operating as intended.

The system achieves this integration by linking the dashboard indicator light to the U-turn signal control module. This connection ensures that the unique U-turn blinking pattern, such as “ON-OFF-ON-ON-OFF,” is faithfully replicated on the dashboard indicator, maintaining synchronization with the external signal. The addition of the U-turn symbol is managed through an electronic overlay or software update to the vehicle's instrument cluster, allowing for straightforward implementation. To enhance global applicability, the dashboard indicator integrates a language-specific cue or universally recognizable symbol tailored to regional preferences, ensuring comprehensibility in diverse markets. This design accommodates vehicles operating in left-hand and right-hand drive configurations, supporting seamless integration into various vehicle models worldwide.

This embodiment significantly enhances driver awareness by providing both visual feedback and operational clarity. The inclusion of the U-turn symbol ensures that drivers can distinguish the U-turn signal from standard turn signals at a glance, reducing the risk of accidental or incomplete signaling. By aligning the dashboard indicator with the external signal, the system promotes safe and deliberate maneuvering during U-turns, contributing to a more intuitive and reliable driving experience.

### IV. Integration of Cameras and Proximity Sensors for Enhanced U-Turn Safety

In one embodiment, the U-turn signaling system is integrated with the vehicle's camera and proximity sensor systems to enhance driver awareness and safety during U-turn maneuvers. When the U-turn signal is activated, the system automatically engages the rear-view and side-view cameras. These cameras provide live video feeds displayed on the vehicle's infotainment screen, allowing the driver to monitor their surroundings in real time. This visual feedback enables the driver to observe approaching vehicles, assess the space required for the turn, and identify potential obstacles in adjacent lanes or behind the vehicle.

The system also utilizes proximity sensors strategically placed around the vehicle to detect objects or pedestrians within the turning path. For instance, sensors positioned near the rear bumper and on the sides of the vehicle monitor the areas most likely to encounter obstacles during a U-turn. If a pedestrian or object is detected, the system emits both audible and visual alerts to notify the driver. These alerts are calibrated to provide timely warnings without causing unnecessary distractions, ensuring that the driver can respond effectively to potential hazards.

For example, consider a scenario where a driver initiates a U-turn on a busy street. Upon activation of the U-turn signal, the system immediately activates the rear-view camera and displays the video feed on the infotainment screen, showing an approaching cyclist in the rear lane. Simultaneously, the side sensors detect a parked car near the turning path and emit a soft beep to alert the driver. This combination of real-time visuals and sensor feedback enables the driver to adjust their maneuver, avoiding both the cyclist and the parked car.

The integration of cameras and proximity sensors is managed by a centralized control module, which coordinates the inputs and outputs of the system. This module interfaces with the vehicle's existing electronics, making the system compatible with a wide range of vehicle models. For vehicles without factory-installed cameras or sensors, aftermarket components can be retrofitted to provide equivalent functionality.

### V. Automatic Adjustment of U-Turn Signal Intensity Based on Ambient Light Conditions

In one embodiment, the U-turn signaling system incorporates an automatic adjustment feature that dynamically modifies the flashing intensity of the signal based on ambient light conditions. This feature leverages integrated light sensors to continuously monitor surrounding light levels, ensuring that the U-turn signal remains highly visible regardless of the time of day or prevailing weather conditions.

During bright daylight hours, the system increases the brightness of the U-turn signal to counteract the high ambient light and ensure the signal is discernible to other drivers and pedestrians. Conversely, during low-light conditions, such as nighttime or in poorly lit areas, the system reduces the brightness to prevent glare that could distract other road users. The flashing rate may also be adjusted as needed to maintain clarity and visibility in varying environments.

For example, if a vehicle activates the U-turn signal on a bright sunny day, the system automatically enhances the brightness of the LEDs to ensure the signal stands out against the daylight. On the other hand, if the U-turn signal is activated on a foggy evening, the system lowers the brightness slightly to prevent excessive glare while maintaining sufficient visibility.

This adaptive functionality is controlled by a central processing unit linked to the light sensors and the vehicle's signaling system. The sensors detect changes in ambient light in real time and relay this information to the control unit, which adjusts the signal parameters accordingly. The seamless operation of this feature ensures that the driver does not need to make manual adjustments, providing a user-friendly and reliable solution.

This embodiment is particularly advantageous for enhancing safety in diverse driving environments. By optimizing the visibility of the U-turn signal, it ensures that the driver's intent is clearly communicated to surrounding road users, thereby reducing the likelihood of accidents caused by misinterpretation or poor visibility. Additionally, the automatic adjustment feature helps conserve energy in vehicles with advanced lighting systems by using only the necessary brightness levels.

### VI. Customizable Flashing Patterns for Different Types of Turns

In one embodiment, the U-turn signaling system supports customizable flashing patterns tailored to different types of turns, such as U-turns and K-turns. This flexibility allows the system to assign a distinct blinking sequence or rate to each type of maneuver, ensuring clear communication with other drivers and pedestrians regarding the specific nature of the vehicle's intended movement.

For U-turns, the flashing pattern may comprise of groups with distinct “ON” and “OFF” durations to signify a continuous directional change, creating a unique and easily recognizable rhythm. In contrast, a K-turn or three-point turn may employ a pattern like “ON-OFF-OFF-ON-ON-OFF-OFF,” emphasizing the sequential and multi-directional nature of this maneuver. These distinctive patterns ensure clear communication of the vehicle's specific intent, enhancing safety and awareness for surrounding road users.

The customizable patterns are designed to be visually distinct from one another and from standard turn signals. This differentiation minimizes confusion for nearby road users, enabling them to anticipate and adapt to the vehicle's movements more effectively. For instance, when a driver initiates a K-turn in a residential area, the associated flashing pattern alerts oncoming traffic to the expected back-and-forth motion, encouraging them to slow down and provide the necessary space.

The customization feature is managed through a control module integrated into the vehicle's signaling system. The module stores preconfigured patterns for various turn types and activates the appropriate sequence based on the driver's input. For example, the driver could select the desired maneuver using a dashboard control panel or through additional inputs, such as extended lever holds or specific button presses. Additionally, the system allows flashing patterns and timing configurations to be preprogrammed for compliance with regional traffic signaling standards, ensuring adaptability to diverse legal requirements and driving practices.

This embodiment enhances safety and communication by providing precise and context-aware signaling for complex maneuvers. The clear distinction between turn types reduces the likelihood of misinterpretation and improves overall road safety. Furthermore, the ability to customize patterns ensures that the system can adapt to evolving traffic regulations or specific vehicle design requirements, making it a versatile and future-proof solution.

### VII. Synchronization of Click Sound with U-Turn Signal Flashing Pattern

In one embodiment, the U-turn signaling system synchronizes the click sound pattern within the vehicle to the unique flashing pattern of the U-turn signal. This alignment creates a cohesive auditory and visual feedback system that enhances driver awareness and reinforces the activation of the U-turn signal. Each illuminated pulse (“ON”) in the U-turn signal's blinking sequence corresponds to an audible click, while each off state (“OFF”) remains silent, ensuring the auditory cue mirrors the signal's rhythm.

For example, if the U-turn flashing pattern is “ON-OFF-ON-ON-OFF,” the corresponding click sound will follow the same sequence, creating a longer duration sound, followed by a pause. This intuitive synchronization helps the driver confirm the signal's operation without needing to rely solely on visual indicators. In cases of patterns with longer illuminated intervals, such as “ON-ON-ON-OFF-ON-ON-OFF,” the extended duration sound provides additional reassurance to the driver that the U-turn signal is actively engaged.

This feature is implemented through integration with the vehicle's existing turn signal audio feedback system. The control module managing the U-turn signal ensures precise timing between the light and sound, maintaining consistency across different flashing patterns. The system can be configured to adjust the volume and tone of the click sound to suit driver preferences or to ensure audibility under varying cabin noise conditions. Additionally, the auditory cue can include language-specific tones or universally recognized sounds to enhance usability across different cultural and regional contexts.

By aligning the auditory cue with the specific U-turn flash pattern, this embodiment supports clear and consistent feedback during U-turn maneuvers. It enhances the driver's ability to monitor the signal's status intuitively, contributing to safer and more deliberate driving practices.

### VIII. Operational Steps of the U-Turn Signaling System

To enhance understanding of the system's functionality, Table 1 outlines the step-by-step operation of the U-turn signaling system:

TABLE 1
Step-by-Step Operational Flow of the U-Turn Signaling System

| Step | Description |
|---|---|
| 1. Driver Activates U- | Via double-click lever, dedicated button, virtual |
| Turn Signal | button, or voice control command. |
| 2. Signal Control | The input is identified as a U-turn signal and |
| Module Processes Input | distinguished from standard turn signals. |
| 3. Generate U-Turn | The system generates the U-turn blinking |
| Blinking Pattern | pattern. |
| 4. Activate Lighting | The existing turn signal lamps are used to |
| System | display the U-turn blinking pattern. |
| 5. Synchronize | The dashboard indicator mirrors the blinking |
| Dashboard Indicator | pattern and include U-turn symbol. |
| 6. Optional: | The click sound inside the vehicle matches the |
| Synchronize Audio | U-turn blinking pattern or special audio which |
| Feedback | is different from the regular turn signal sound. |
| 7. Signal Automatically | The U-turn signal turns off after the maneuver |
| Deactivates | is complete (e.g., based on steering wheel |
| | alignment). |

1. A U-turn signaling system for a vehicle, comprising:
a) a control module configured to activate a U-turn signal;
b) a lighting system configured through a dual-pattern flasher module to generate both the standard turn signal pattern and a distinct U-turn blinking pattern, without requiring additional external lighting hardware, the lighting system being integrated with the vehicle's existing turn signal lighting infrastructure;
c) wherein the U-turn blinking pattern comprises a sequence of illuminated (“ON”) and off (“OFF”) states, wherein:
i. each “ON” represents the light being illuminated for a defined duration; and
ii. each “OFF” represents the light being off for a defined duration; and
iii. the U-turn blinking pattern includes at least two distinct groups of “ON” and “OFF” durations that are visually and temporally different from one another;
d) wherein the blinking pattern for the U-turn signal is distinct from the standard turn signal pattern, which uses uniform “ON” and “OFF” durations, ensuring the U-turn signal is visually recognizable as a unique pattern; and
e) wherein the duration of each “ON” and “OFF” state is configurable to adapt to varying lighting and traffic conditions.

2. The system of claim 1, wherein the duration of each “ON” (illuminated) state is configurable between approximately 0.4 seconds and 1 second.

3. The system of claim 1, wherein the duration of each “OFF” (off) state is configurable between approximately 0.2 seconds and 1 second.

4. The system of claim 1, wherein the distinct U-turn blinking pattern comprises a sequential or chaser-style illumination pattern characterized by groups of illumination sequences having at least two visually distinguishable sequential flash rates.

5. The system of claim 1, wherein the lighting system comprises LED arrays positioned on the front and rear of the vehicle, configured to enhance visibility for surrounding drivers and pedestrians.

6. The system of claim 1, wherein the control module enables activation of the U-turn blinking pattern via at least one of:
i) a double-click of the existing turn signal lever;
ii) a dedicated U-turn activation button on the turn signal lever;
iii) a virtual button integrated into the vehicle's infotainment system; or
iv) a voice-activated command linked to the vehicle's voice assistant system.

7. The system of claim 1, further comprising a synchronization mechanism configured to align the auditory click sound pattern with the U-turn blinking pattern, wherein each illuminated state (“ON”) corresponds to a click sound, and each off state (“OFF”) is silent, providing auditory feedback to the driver.

8. The system of claim 6, wherein the virtual button integrated into the vehicle's infotainment system activates a visual U-turn symbol indicator on the dashboard display corresponding to the U-turn signal.

9. The system of claim 1, further comprising an automatic adjustment mechanism configured to dynamically modify the brightness of the U-turn signal based on ambient light conditions detected by integrated light sensors, thereby ensuring optimal visibility and conserving energy.

10. The system of claim 1, wherein the control module is programmed to allow customizable U-turn blinking patterns, enabling additional sequences beyond the quadruple-pulse pattern for specific driver preferences or regulatory compliance.

11. The system of claim 1, further comprising a proximity detection system and camera integration, wherein activation of the U-turn signal triggers:
live camera feeds displayed on the vehicle's infotainment screen, and
alerts to the driver of obstacles or pedestrians in the vehicle's turning path.

12. The system of claim 1, wherein the dual-pattern flasher module can be updated via software to introduce new flashing patterns or enhance existing ones.

13. The system of claim 1, wherein the dual-pattern flasher module is implemented by modifying or replacing the vehicle's existing turn signal flasher.

14. The system of claim 1, wherein the timing configuration for the illuminated and off states can be manually adjusted by the driver or preconfigured based on regional traffic regulations.

15. The system of claim 1, wherein additional U-turn blinking patterns can be added or modified through software updates to the control module.

16. The system of claim 1, wherein the control module is configured to adapt activation methods and signal timing based on vehicle configuration, including left-hand and right-hand drive designs.

17. The system of claim 1, wherein the U-turn blinking pattern and timing configuration are preprogrammed to comply with regional traffic signaling standards.

18. The system of claim 6, wherein the activation method is positioned ergonomically based on the driver's seating location, accommodating both left-hand and right-hand drive vehicles.

19. The system of claim 8, wherein the dashboard indicator integrates a language-specific or symbol-based cue to accommodate different regional languages.
